(19) United States
(12) Patent Application Publication
(10) Pub. No.: US 2003/0141682 A1
(43) Pub. Date: Jul. 31, 2003

(54) Snow glider ski scooter

(76) Inventor: Joshua Alexander Comden, Harleysville, PA (US)

Correspondence Address: Joshua Comden, 207 Alderfer Road, Harleysville, PA, 19438, US

(21) Appl. No.: 10/059,967

(22) Filed: Jan. 30, 2002

(51) Int. Cl. B62B 9/04

(52) U.S. Cl. 280/14.28

(57) ABSTRACT

A vehicle comprised of skies on the bottom and a folding device for means of storage and portability and a brake system for means of stopping. The skies allow the user to travel short distances on snow or ice. The collapsing device is based on locking the vehicle in an upright or collapsed position. The brake system is made up of a hinge, a spring, and a piece that digs into the snow to increase friction between the vehicle and the snow, when the user puts pressure on the top of the brake. The brake is located on the back of the vehicle. The result is a vehicle that allows the user to travel short distances on snow in a standing position. This also allows the user to travel down snowy hills as a kind of sled, in a stand up position.

### CROSS-REFERENCE TO RELATED APPLICATIONS

U.S. Patent Documents:

U.S. Pat. No. 5,927,733 Banda July, 1999 280/87

U.S. Pat. No. 6,139,035 Tsai October, 2000 280/87

### STATEMENT REGARDING FEDERALLY SPONSORED RESEARCH OR DEVELOPMENT

Not Applicable cl REFERENCE TO A MICROFICHE APPENDIX

Not Applicable

### BACKGROUND OF THE INVENTION

This invention relates to transportation on snow in a stand up position. More specifically, this invention relates to a style of scooter in which the user may fold the scooter to store or carry the scooter more easily, but with skies on the bottom instead of wheels for transportation on snow and ice.

In prior art system the most popular style of scooter has 2 wheels and is foldable. Scooters of this variety are low to the ground and have a closing device. The closing device allows the scooter to be folded into a smaller position. This device is a hinge that locks the shaft that supports the handle bar to the scooter in an up position or collapsed position. These scooters allow the user to make the shaft that supports the handle bar collapsible because half the length of the shaft can slide into the other half. The user simultaneously puts pressure on the top and the release button. When both smaller positions are reached, it allows the user to store or carry the scooter more easily.

The handlebar that the shaft supports allows the user to place his/her hands on it to steer the front wheel that then turns the scooter in motion. The handlebar has two release buttons in which the user may put pressure and pull the sides of the handlebar out to allow it to be stored more easily. A piece of elastic cord is strung through the handle bar and attached the two opposite ends to hold the two ends loosely close to the prior art system. The user stands on the horizontal, rectangular platform that is on the opposite end of the shaft that supports the handle bar. The shaft that supports the handle bar is attached to the edge of the platform by the front folding device. On the back of the platform is a brake. The brake is a semicircle supported by a hinge and a spring in the air over the back wheel. When the user puts pressure on the top of the brake it puts friction on the back wheel and stops the wheel from moving and stops the scooter from moving.

A problem associated with this the prior art system is that the user can not use the scooter in snowy weather. The scooter wheels need smooth stable ground. Where snow may be smooth but not stable and the user will sink down into the snow. The snow will increase friction and then slow down the scooter and the user. Another problem associated with the prior art system is the brake on the back wheel will not help stop the scooter on snow and ice.

### BRIEF SUMMARY OF THE INVENTION

Scooters have become a popular way to travel short distances. Scooters have become a way of traveling stylishly. The problem with scooters is that they are hard to use on snow and ice. Being able to travel on snow with a scooter would allow people to travel when streets or sidewalks have not yet been shoveled.

The present invention allows the user to travel short distances on snow and ice. The present invention is foldable just as the prior art system. The present in invention has skies on the bottom to allow the user to travel on snow and ice. Brakes on the present invention dig into the snow and ice to increase friction and stop the present invention in motion. Ridges on the bottom of front steering ski on the present invention help steer when the user turns the handlebars. The ridges help guide the present invention to steer at a more precise time.

### BRIEF DESCRIPTION OF THE SEVERAL VIEWS OF THE DRAWING

FIG. 1 is side perspective view in a usable up position.

FIG. 2 is side perspective view in a storable collapsed position.

FIG. 3 is top perspective view in a usable up position.

FIG. 4 is top perspective view in a storable collapsed position.

FIG. 5 is front perspective view in a usable up position.

FIG. 6 is front perspective view in a storable collapsed position.

FIG. 7 is back perspective view in a usable up position.

FIG. 8 is back perspective view in a storable collapsed position.

FIG. 9 is an enlarged sectional view of the brake from the bottom.

FIG. 10 is an enlarged sectional view of the brake from the side.

FIG. 11 is an enlarged sectional view of the release button in the handlebar from the back.

FIG. 12 is an enlarged sectional view of the release button in the handlebar from the side.

### DETAILED DESCRIPTION OF THE INVENTION

The present invention allows the user to travel short distances on snow and ice. When the user places the present invention on snow or ice, it allows the user to glide on the surface of the snow with less friction to move easier.

This is accomplished by using skies 10 and 14 on the bottom of the present invention that allows the user to glide on the snow's surface. The curved portion of ski 10 is 11 that allow the snow to be pushed under ski 10. The curved portion of ski 14 is 15 that allow snow to be pushed under ski 14. There are guides 12 and 12′ on the bottom of the front, steering ski so when the user turns the handlebar, the guides 12 and 12′ grip the snow or ice and guide the present invention to steer at a more precise time than without them. The front portion of guides 12 and 12′ are portions 13 and 13′ that allows the guides 12 and 12′ to be more aerodynamic. The handle bar allows the user to direct the present invention to the desired direction. Sleeve 56 and 56′ allows the users hands not to slip off sleeve 64 and 64′. Sleeve 65 and 65′ allows the user's hands not to slip inward. Shaft 66 holds shaft 76 inside and release buttons 68 and 68′.

The user places his/her left hand on sleeve 64′ and places right hand on sleeve 64. When the user wants to turn left in motion, he/she pulls on sleeve 64′ and pushes on sleeve 64. When the user wants to move right he/she pulls on sleeve 64 and push on 64′. When the user wants to move on level or an up slope, he/she places desired foot on platform 19 and pushes opposite foot on snow or ice. When the user wants to move on a down slope, he/she places both feet on platform 19 and balance him/her self.

Vertical shafts connect the handlebars to the front steering ski. Shaft 40 holds ski 15 to the present invention. Pivot 41 allows shaft 40 to spin. Socket 42 holds and supports pivot 41 to shaft 43. Sleeve 43 allows sleeve 47 to spin inside sleeve 43 and be connected to shaft 40. Socket 44 allows shaft 47 to spin in a smooth manner. Nuts 45 and 46 help hold sleeve 47 to shaft 60. Shaft 60 has spiral thread to hold sleeve 47 together. Clamp 48 squeezes tight sleeve 47 over shaft 60. Bolt 49 holds clamp 48 in place. The user stands on the horizontal, rectangular platform 19 that is on the opposite end of the shaft that supports the handle bar. On the bottom of platform 19 is portion 18 that supports platform 19. At same end as the collapsing device of platform 19 is platform portion 32 that give the present invention more aerodynamics.

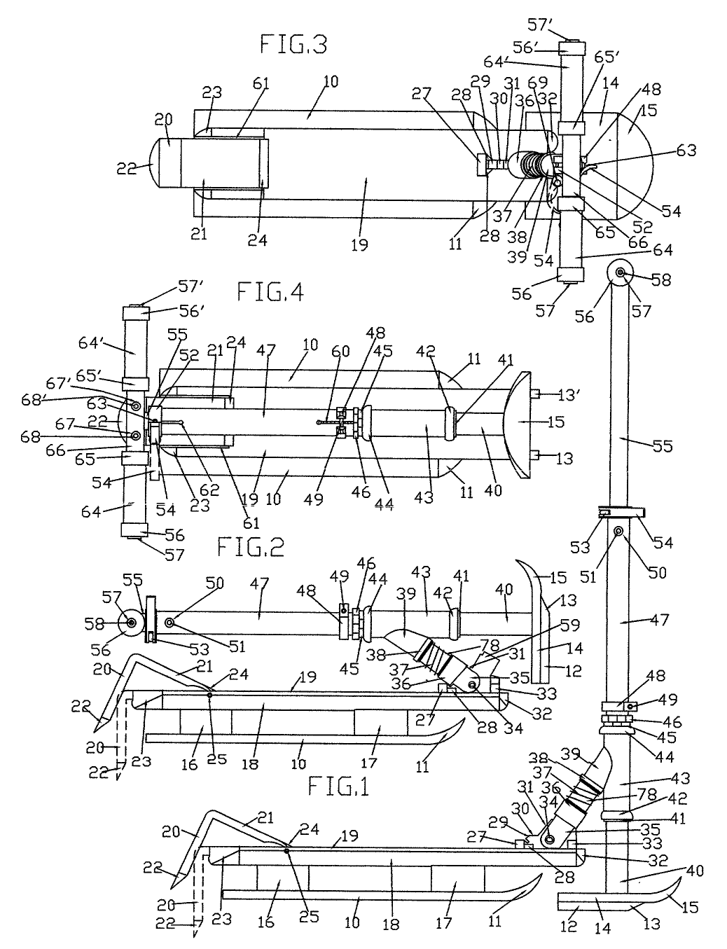

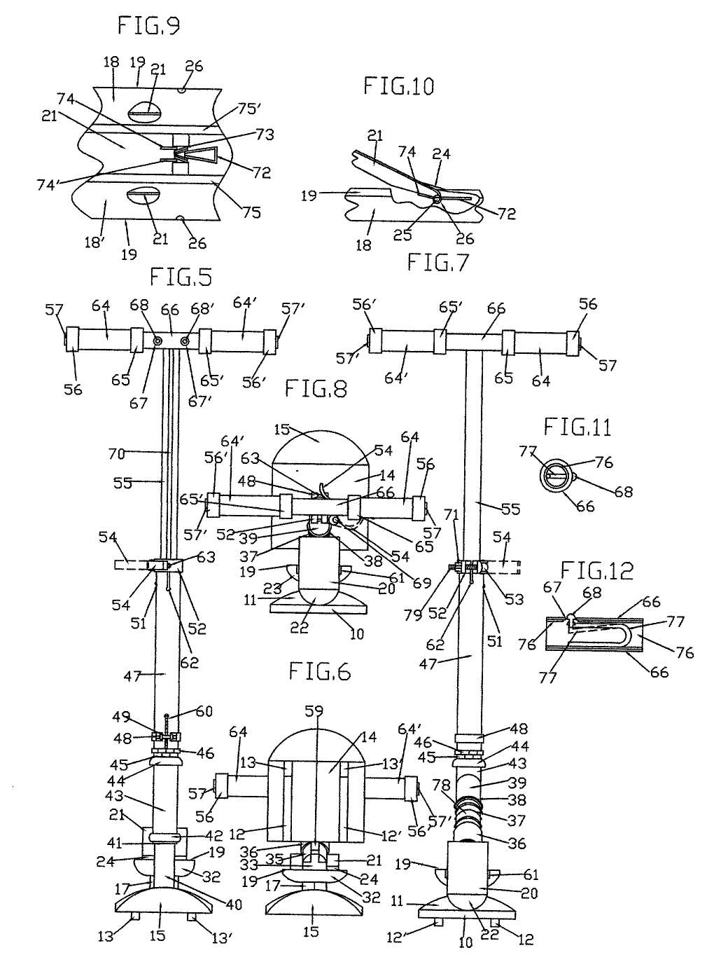

This present invention is low to the ground and has a collapsing device. The collapsing device allows the present invention to be folded into a smaller position. This device is a hinge that locks the present invention in an up position or collapsed position. Body 27 and 28 support locking band 36 when in the collapsed position as in FIG. 2, FIG. 4, FIG. 6, and FIG. 8. Locking band 36 holds the present invention in the collapsed position or upright position. The user my apply pressure upward on locking band 36 and at the same time push sleeve 47 to the back and down to bring the front end of the present invention parallel to platform 19. Then the user releases all pressure from locking band 36 and allow spring 37 to push locking band 36 over body 29 and while body 31 supports locking band 36 in one place. If the user needs to have sleeve 47 perpendicular to platform 19, he/she pulls locking band 36 towards spring 37 and pushes sleeve 47 up and front. Then the user releases locking band 36 and that allows spring 37 to push locking band 36 over body 59. Body 59 supports inside locking band 36 in the upright position. Shaft 78 supports and holds spring 37 in place. Body 29 and 30 also supports locking band 36 when in the collapsed position but on the inside of locking band 36. Body 31 supports locking band 36 in the upright position as in FIG. 1, FIG. 3, FIG. 5, and FIG. 7. Shaft 35 supports and allows locking band 36 to slide up and down. Body 33 supports shaft 35 in the upright position. Bolt 34 allows shaft 35 to hinge upright to collapsed position and back. Sleeve 38 supports and holds spring 37 from sliding up shaft 39. Shaft 39 connects the collapsing device to sleeve 43.

On the back of platform 19 is a brake. This portion 21 of the brake is supported in the air by a spring and a hinge. The hinge is made up of bolt 25 that holds spring 73 in place. Portion spring 72 is attached to bottom of platform 19. Portion spring 74 and 74′ are attached to the bottom of brake portion 21. The brake portion 21 is held in the air at a 23-degree angle towards the back. The brake portion 21 is a quarter of an inch longer than its placement on the platform 19. Edge 75 and 75′ are the bottom of portion 18. At the end of the brake is a portion 20 that is almost the width of the platform and is at a 90-degree angle from brake portion 21. At the end of brake portion 20 is brake portion 22. That when the user puts pressure on the brake portion 21, the brake portions 20,21,22 goes down and brake portion 22 and part of brake portion 20 digs into the snow or ice, referring to the alternate position in FIG. 1 and FIG. 2. At the end of platform 19 is platform portion 23 that holds and supports brake portion 21 when the alternate position is reached in FIG. 1 and FIG. 2. At the end of brake portion 21 is brake portion 24 that holds and supports brake portion 21 in the upright position. Brake guide 61 allows brake portion 21 to go into platform 19. When that happens, the brake increases the friction between the present invention and the snow or ice, and stops the user and present invention in motion. Under the bottom of the portion 18 is the main ski 10, held by small triangular prisms 16 and 17 for aerodynamics and height to keep off of snow or ice.

The present invention allows the user to make shaft 55 that supports the handle bar to be collapsible into sleeve 47 because shaft 55 has a lesser diameter than sleeve 47. The user simultaneously puts pressure on the top and the release button 51. Release button 51 and release button 68′ works exactly like release button 68 as referred in FIG. 11 and FIG. 12. Hole 51 and hole 67′ work exactly like hole 67 as referred in FIG. 11 and FIG. 12. Hole 67 allows release button 68 to be pushed into its alternate position as referring to FIG. 12. Release button 68 holds and supports shaft 76. When release button 68 is pushed in alternate position the user may pull out shaft 76 that holds sleeve 64. Spring 77 pushes release button up through hole 67. Clamp 52 help supports sleeve 47 to shaft 55 in the upright or collapsed position. Eyebolt 53 allows fastener 69 to pivot like a hinge. Nut 71 holds portion eyebolt 79 in place. Portion eyebolt 79 is a portion of eyebolt 53 but threaded. Fastener 69 holds and supports body 54 body. 54 acts as the arm in a second class lever. When body 54 is tight against clamp 52 the thick part of body 54 around fastener 69 tightens clamp 52. When body 54 is in its alternate position, body 54 releases the pressure on clamp 52 and allows shaft 55 to be loose. Hole 62 allows clamp 52 to squeeze tight around shaft 55. Shaft 55 holds and supports shaft 66. Bolt 63 holds clamp 52 to sleeve 47. Indent 70 allows clamp 52 to guide shaft 55 into sleeve 47. The handlebar has two release buttons in which the user may put pressure and pull out the sides of the handlebar out. Elastic cord 58 is strung through the handle bar and attached the two opposite handle plugs 57 and 57′ to hold the two ends loosely close to the present invention. When all smaller positions are reached, it allows the user to store or carry the scooter more easily.

Being able to travel on snow and ice with the present invention would allow people to travel when streets or sidewalks have not yet been shoveled. The user can use the present invention on a snowy hill as a kind of sled or snowboard.

I claim:

1. A device of the class described comprising, two like width but differing length in-line skis; a handle bar connected to the platform on which the user stands ski having a shaft; a frame interconnecting said handle bar providing for the steering thereof, to permit relative angular movement of the front ski.

2. A device of the class described comprising, inside and outside handle bar sleeves mounted on the handle bar to prevent inward or outward movement of the hands on the handle bar.

3. A device of the class described comprising, handle bar and handle bar sleeves mounted on a vertical shaft having a grove channel therein fitting into a sleeve through a clam that, when engaged, halts the movement of the shaft into sleeve and when disengaged allows the movement of the shaft into the sleeve.

4. A device of the class described comprising, handle bar and handle bar sleeves mounted on a vertical shaft fitting into a sleeve, which sleeve is attached to another shaft by means of a screw fitting with the base of the sleeve which corresponds to the screwed end of the shaft.

5. A device of the class described comprising, handle bar and handle bar sleeves mounted on a vertical shaft fitting into a sleeve, which sleeve is attached to another shaft by means of a screw fitting with the base of the sleeve which corresponds to the screwed end of the shaft through which passes into a sleeve which sleeve allowing for the circumferencal movement of the shaft within the sleeve.

6. A device of the class described comprising, handle bar and handle bar sleeves mounted on a vertical shaft fitting into a sleeve, which sleeve is attached to another shaft by means of a screw fitting with the base of the sleeve which corresponds to the screwed end of the shaft through which passes into a sleeve which sleeve allowing for the circumferencal movement of the shaft within the sleeve, which shaft is connected to the top of the front in-line ski.

7. A device of the class described comprising, the foregoing to the bottom of which are attached two evenly spaced guide rails running the length of the front ski.

8. A device of the class described comprising, handle bar and handle bar sleeves mounted on a vertical shaft fitting into a sleeve, which sleeve is attached to another shaft by means of a screw fitting with the base of the sleeve which corresponds to the screwed end of the shaft through which passes into a sleeve which sleeve allowing for the circumferencal movement of the shaft within the sleeve, which sleeve is connected to a shaft set at an angle and which connects to the platform.

9. A device of the class described comprising, handle bar and handle bar sleeves mounted on a vertical shaft fitting into a sleeve, which sleeve is attached to another shaft by means of a screw fitting with the base of the sleeve which corresponds to the screwed end of the shaft through which passes into a sleeve which sleeve allowing for the circumferencal movement of the shaft within the sleeve, which sleeve is connected to a shaft set at an angle over which passes a spring and locking band to secure the shaft to the platform in an upright or collapsed position.

10. A device of the class described comprising, handle bar and handle bar sleeves mounted on a vertical shaft fitting into a sleeve, which sleeve is attached to another shaft by means of a screw fitting with the base of the sleeve which corresponds to the screwed end of the shaft through which passes into a sleeve which sleeve allowing for the circumferencal movement of the shaft within the sleeve, which sleeve is connected to a shaft set at an angle which is connected to a mounting bracket which mounting bracket is connected to the platform.

11. A device of the class described comprising, the foregoing to the bottom of which platform is mounted two, in-line triangular prism mounting blocks to which is mounted the rear in-line ski.

12. A device of the class described comprising, the top of the platform to which is connected a mounting.

13. A device of the class describe comprising, the top of the platform to which is connected a mounting which mounting has within it a spring which engages and disengages the braking device.

14. A device of the class describe comprising, the top of the platform to which is connected a mounting which mounting has within it a spring which engages and disengages the braking device, which is “L” shaped and which braking device is attached to the mounting by way of a bolt.

15. A device of the class describe comprising, the braking device which moves vertically against and with the spring in the mounting device.

16. A device of the class described comprising, the platform to which is connected a mounting which platform has a channel at its rear end aft of the mounting device into which the braking device fits.
